(19) United States
(12) Patent Application Publication
(10) Pub. No.: US 2012/0259593 A1
(43) Pub. Date: Oct. 11, 2012

(54) METHOD FOR THE PREDICTION OF FATIGUE LIFE FOR WELDED STRUCTURES

(76) Inventors: Mohamad S. El-Zein, Bettendorf, IA (US); Rakesh K. Goyal, Pune (IN); Grzegorz Glinka, Ontario (CA)

(21) Appl. No.: 13/082,195

(22) Filed: Apr. 7, 2011

(51) Int. Cl. G06F 17/10; G06G 7/48

(52) U.S. Cl. 703/1

(57) ABSTRACT

A method of determining the fatigue life of a welded structure, including the steps of: creating a 3D coarse mesh model of the welded structure to be analyzed; analyzing the coarse mesh model using an FEA model to generate FEA data; identifying a critical stress location on the coarse mesh model having a through thickness stress distribution, based on the FEA data; post processing the FEA data in the middle portion of the through thickness stress distribution while excluding the through thickness stress distribution near the edges of the identified critical stress location to determine a peak stress; and determining a fatigue life of the welded structure at the identified critical stress location, dependent on the determined peak stress.

### FIELD OF THE INVENTION

The present invention relates to methods for determining the structural integrity of a chassis in work vehicles, and, more particularly, to analysis methods for determining the fatigue life of welded structures in such work vehicles.

### BACKGROUND OF THE INVENTION

Work vehicles, such as agricultural, construction, forestry or mining work vehicles, typically include a chassis carrying a body and a prime mover in the form an internal combustion engine. The chassis may also carry other structural components, such as a front-end loader, a backhoe, a grain harvesting header, a tree harvester such as a feller-buncher, etc.

The chassis itself typically includes a number of structural frame members which are welded together. The size and shape of the frame members varies with the particular type of work vehicle. Given the external loads which are applied to the work vehicle, it is also common to use reinforcing gusset plates and the like at the weld locations of the frame members to ensure adequate strength.

With any such type of work vehicle, it is of course necessary to ensure that the chassis of the vehicle is sufficiently strong to withstand externally applied loads, vibration, etc. over an expected long life of the vehicle. Over the past couple of decades, the use of finite element analysis (FEA) techniques has become increasingly more common to analyze both dynamic and static loads which are applied to the chassis of the vehicle. Typically a three dimensional (3D) model of the structure to be analyzed is generated, with the 3D model including a number of nodes defined by a 3D coordinate system. An FEA software program or model is used to calculate the dynamic and/or static loads at each of the nodes. This type of FEA analysis is typically always done with a computer because of the computational horse-power required to calculate the loads at each of the nodes.

The use of coarse through the thickness finite element (FE) meshes can be inaccurate because the FE size of a coarse mesh is often larger than the high stress gradient region near the weld toe. The coarse FE mesh does not allow for accurate determination of the stress concentration at the weld toe nor is it capable of accurately determining the through the thickness stress distribution. The stress concentration cannot be extracted from the coarse 3D FE data because the weld toe, weld root and other notch-like regions are modeled as sharp corners. On the other hand, welded structures which require the use of a very fine mesh in the weld toe and root region in order to extract the stress concentration and stress distribution in the weld toe region require prohibitively complex 3D FE models and a very large number of FE's when modeling complete 3D welded structures.

What is needed in the art is a method of accurately determining the fatigue life of welded structures, without the need to use computationally expensive fine mesh FEA models for critical stress locations.

### SUMMARY

The present invention provides a method of determining the fatigue life of a welded structure, wherein a coarse mesh FEA model is first used to identify critical stress locations, and then the FEA data is post processed in the approximate middle half of the through thickness stress distribution (±10%) at the identified critical stress locations to calculate a peak stress value used to determine the fatigue life of the welded structure.

The invention in one form is directed to a method of determining the fatigue life of a welded structure, including the steps of: creating a 3D coarse mesh model of the welded structure to be analyzed; analyzing the coarse mesh model using an FEA model to generate FEA data; identifying a critical stress location on the coarse mesh model having a through thickness stress distribution, based on the FEA data; post processing the FEA data in the middle portion of the through thickness stress distribution while excluding the through thickness stress distribution near the edges of the identified critical stress location to determine a peak stress; and determining a fatigue life of the welded structure at the identified critical stress location, dependent on the determined peak stress.

The invention in another form is directed to a computer-based method of determining the fatigue life of a welded structure using a computer having at least one processor and at least one memory, said method comprising the following steps which are each sequentially carried out within the computer: creating a 3D coarse mesh model of the welded structure to be analyzed; analyzing the coarse mesh model using an FEA model to generate FEA data; identifying a critical stress location on the coarse mesh model having a through thickness stress distribution, based on the FEA data; post processing the FEA data in the middle portion of the through thickness stress distribution while excluding the through thickness stress distribution near the edges of the identified critical stress location to determine a peak stress; and determining a fatigue life of the welded structure at the identified critical stress location, dependent on the determined peak stress.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a block diagram illustrating a multiaxial state of stress at a weld toe location;

FIG. 2 is another block diagram of a plate on plate welded T joint structure;

FIG. 3 is an end view of the welded T joint structure shown in FIG. 2;

FIG. 4 is an end view of the welded T joint structure shown in FIG. 2, with a 2D coarse mesh model overlaid thereon;

FIG. 5 illustrates the critical cross-sections (along with relevant stress components to be extracted, e.g., extract σxx if section-1 is critical or extract σyy if section-2 is critical) in the welded T joint structure shown in FIGS. 2-4;

FIG. 6 illustrates the membrane and bending hotspot stresses in the critical cross-sections;

FIG. 7 illustrates three levels of an FE mesh model representing a welded structure;

FIG. 8 illustrates the use of a fine FE mesh in regions of the welded structure close to the weld toe;

FIG. 9 illustrates a complete FE model of a welded structure which is constructed using a fine FE mesh in the weld toe/root region and a coarse FE mesh in a region away from the weld toe/root region;

FIG. 10 is a block diagram illustrating the nominal stress and hotspot stress resulting from the linearization of a through thickness stress distribution;

FIG. 11 illustrates the membrane and bending hotspot stresses from a fine FE mesh model using discrete stress data, based on an approximate numerical integration method;

FIG. 12 illustrates the membrane and bending hotspot stresses from discrete coarse FE mesh stress data, using an analytical integration method;

FIG. 13 illustrates an example of a gusset welded joint;

FIG. 14a illustrates a coarse FE mesh model of a gusset welded joint with four linear elements per plate thickness;

FIG. 14b illustrates a coarse FE mesh model of a gusset welded joint with eight linear elements per plate thickness;

FIG. 15 illustrates the through thickness stress distribution in a gusset plate welded joint under bending load, with the through thickness stress distribution being generally independent of the FE mesh size in the middle portion of the plate thickness;

FIG. 16 illustrates the through thickness stress distribution in the gusset plate under bending load, with variable notations indicated for the bending moment;

FIG. 17 illustrates examples of geometrically non-symmetric welded joints;

FIG. 18 illustrates examples of geometrically symmetric welded joints;

FIG. 19 illustrates a symmetric butt weld under axial load;

FIG. 20 illustrates a symmetric butt weld under bending load;

FIG. 21 illustrates a symmetric fillet weld under axial load;

FIG. 22 illustrates a symmetric fillet weld under bending load;

FIG. 23 illustrates a non-symmetric fillet weld under axial load;

FIG. 24 illustrates a non-symmetric fillet weld under bending load;

FIG. 25 is a schematic block diagram of a computer which may be used to carry out the method of the present invention for the prediction of fatigue life for welded structures; and

FIG. 26 is a high level flowchart illustrating the method of the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION

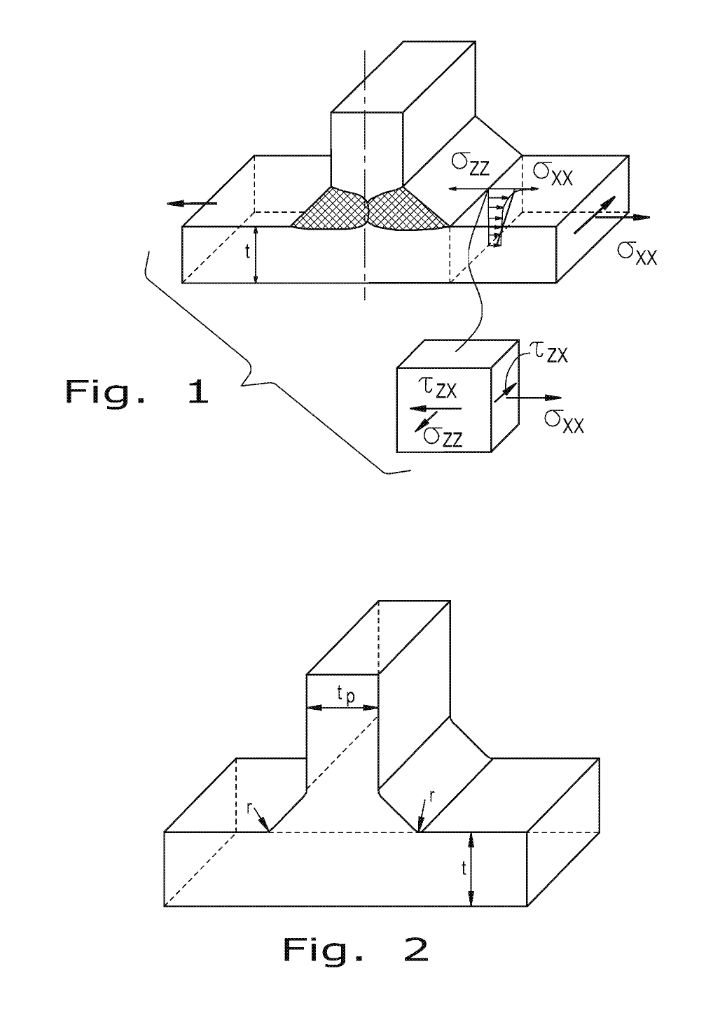

Referring now to the drawings, the method of the present invention for determining the fatigue life of a welded structure will be described in greater detail. The methodology of the present invention is sequentially set forth below, along with generalized mathematical equations and equations for a specific example of a welded structure. In the specific example, the welded structure is assumed to be a 3D geometry of a double fillet T-joint as shown in FIG. 1 including all geometrical details. Any such structure like that one (FIG. 2) can be often modeled using either 3D coarse or 3D fine FE mesh. When the coarse FE mesh is used the weld toe is modeled as a sharp corner as shown in FIG. 3. Because the purpose of the coarse FE mesh analysis is not to get stresses in the weld toe region then relatively large finite elements can be used. (The smallest finite element size, in the method described below, does not need to be less than 25% of the plate thickness ‘t’ or the weld length ‘h’, i.e., Δₑₗ<0.25t or Δₑₗ<0.25h.)

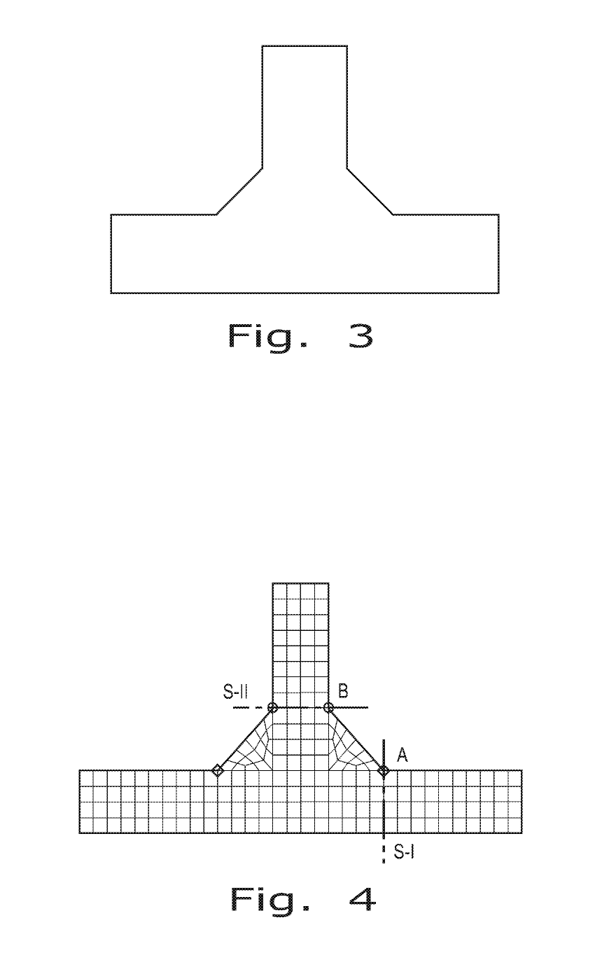

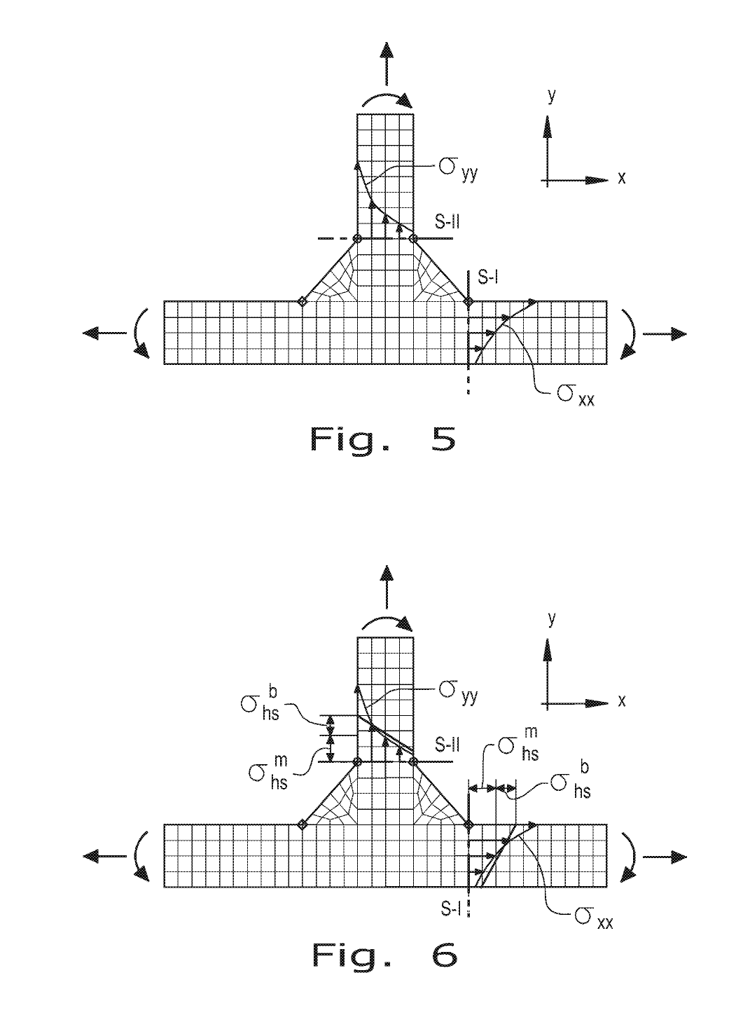

Critical cross sections, i.e., all sections containing the weld toe and the critical points in those sections are denoted (FIG. 4) by points A and B in both the attachment and the base plate respectively. The cross section S-I (FIG. 5) represents the weld toe cross section in the base plate and the cross section S-II represents the weld toe cross section in the attachment, respectively. The cross sections S-I and S-II are located at the transition between the weld and the plate.

The transition points (points A and B) or the adjacent points experience the highest stress concentration. Stresses σₓₓ(y) in the base plate cross section S-I are needed for the fatigue analysis of the base plate and stresses σ_{yy}(x) in the cross section S-II are needed for the fatigue analysis of the attachment.

### The Stress Determination Procedure by Using the Coarse Fe Mesh and Subsequent Post Processing are as Follows:

1. Extract the distribution of the normal stress component in the critical cross section S-I or S-II shown in FIG. 5. This means that it is necessary to extract normal stresses σₓₓ(y) in the cross section S-I for the fatigue analysis of the base plate and the normal stresses σ_{yy}(x) in the cross section S-II for the fatigue analysis of the attachment.
2. Calculate the membrane and the bending stress, σₕₛ^{m} and σₕₛ^{b}, respectively in the plate cross section (FIG. 6) using the through-thickness coarse mesh FE stress distribution σₓₓ(y) and σ_{yy}(x). (Because the weld toe is modeled as a sharp corner and the use of relatively coarse mesh, the peak stress in the corner is highly inaccurate and cannot be directly used in determination of the bending hot spot stress; see the procedure described below).
3. Calculate the local peak stress at the weld toe using the following formula:

σₚₑₐₖ=σₕₛ^{m}·K_{t,hs}^{m}+σₕₛ^{b}·K_{t,hs}^{b} (3)
It has been found that the most universal stress concentration formulae are those derived by Japanese researchers and they are described below.
4. Determine the through-the-thickness stress distribution in the analyzed section using the Monahan general equation (it has been written here for the section S-I) in the form of eq. (4).
5.

$${σ}_{xx} ( y ) = [ \frac{{K}_{t , hs}^{m} {σ}_{hs}^{m}}{2 \sqrt{2}} \cdot \frac{1}{{G}_{m}} + \frac{{K}_{t , hs}^{b} {σ}_{hs}^{b}}{2 \sqrt{2}} \cdot \frac{1 - 2 ( \frac{y}{t} )}{{G}_{b}} ] [ {( \frac{y}{r} + \frac{1}{2} )}^{- \frac{1}{2}} + \frac{1}{2} {( \frac{y}{r} + \frac{1}{2} )}^{- \frac{3}{2}} ] \qquad ( 4 )$$

6. Proceed to fatigue analyses.

The stress peak (eq.3) amplitude and the mean stress of each stress cycle are needed for the fatigue life prediction based on the local strain-life approach. The through thickness stress distribution and its fluctuations are necessary for Fracture Mechanics analyses.

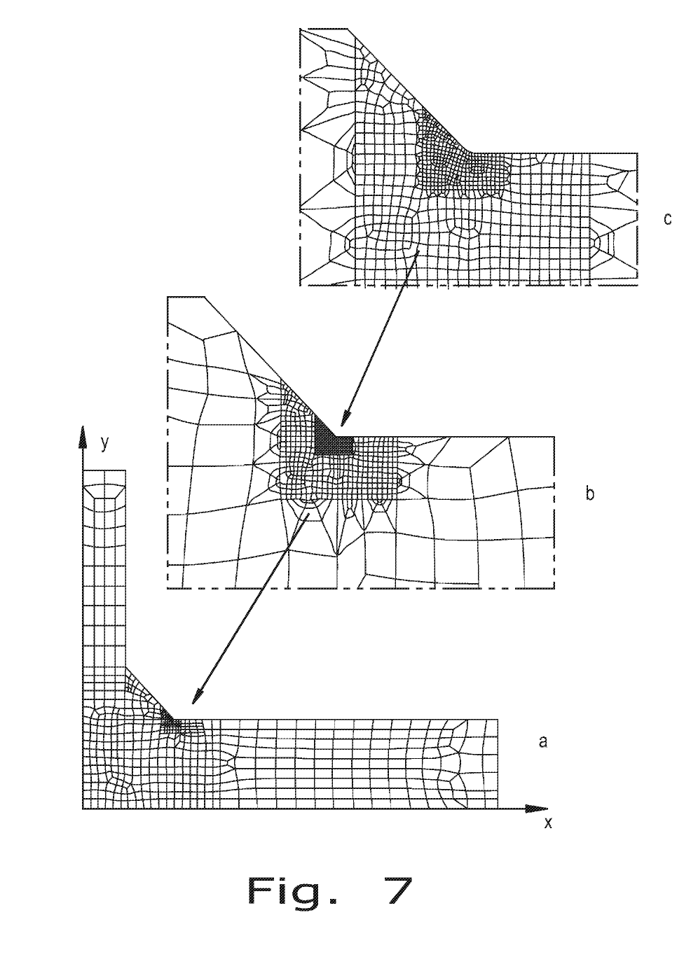

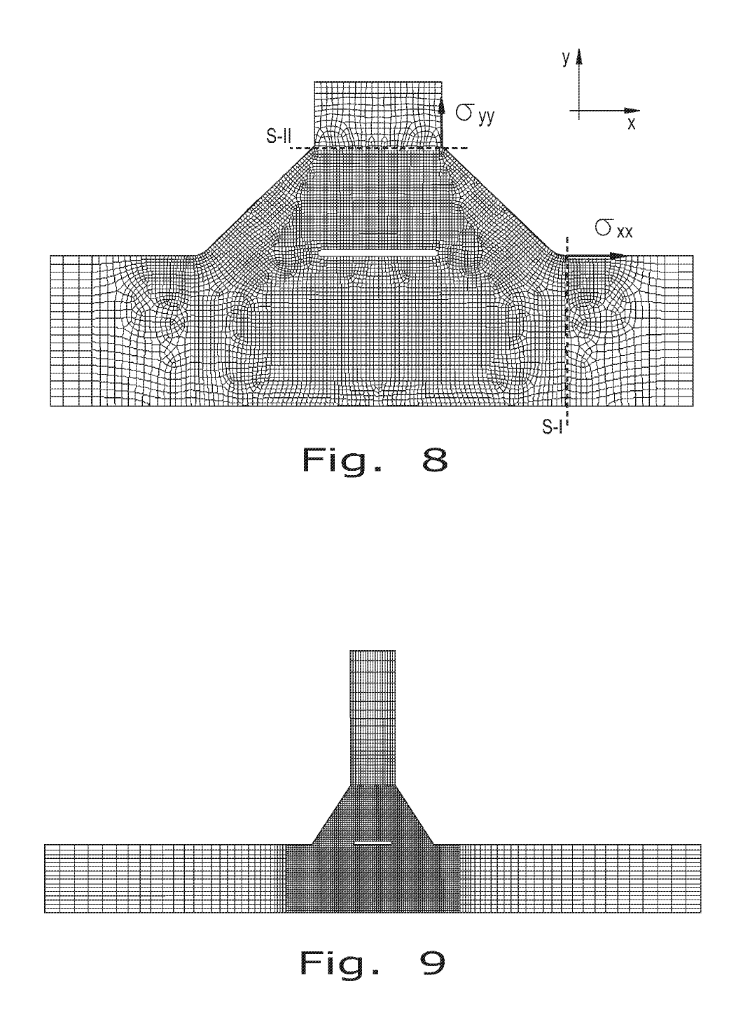

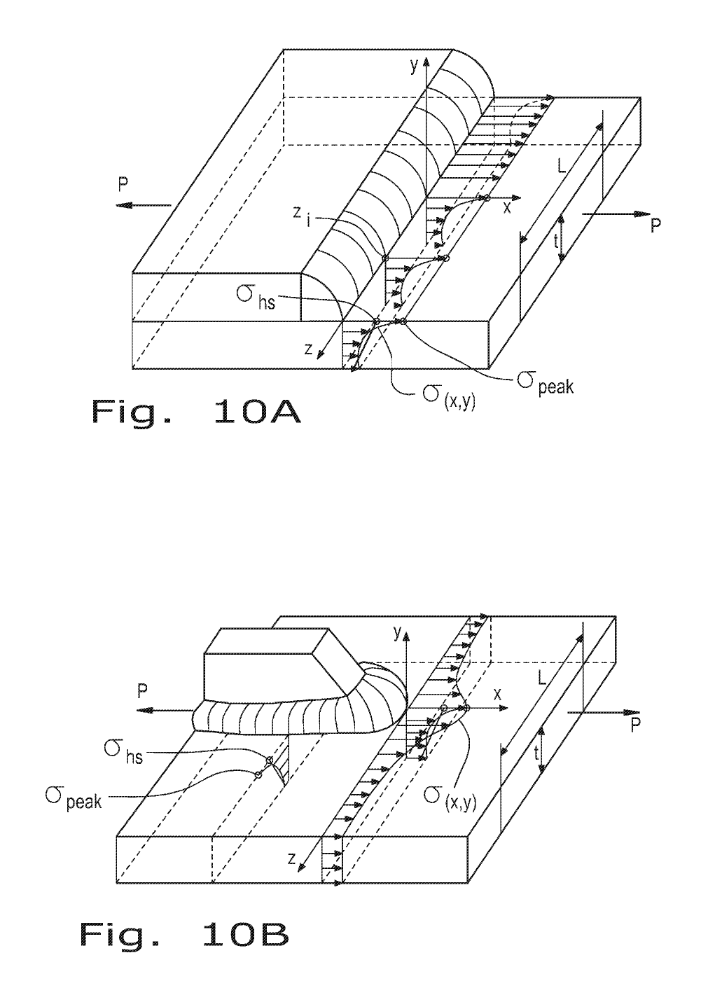

Equations (3) and (4) are needed in order to determine the peak stress and the stress distribution in the critical cross section based on stress data obtained from the coarse FE mesh model of analyzed welded joint. The peak stress and the through thickness stress distribution obtained from the coarse FE mesh model cannot be directly used for fatigue analyses because of insufficient accuracy. However, the membrane and bending hot spot stresses when properly determined can be accurate because they are only very weakly dependent on the finite element size. Therefore when combined with appropriate stress concentration factors (eq. 3) and Monahan's equations (eq. 4) reasonably accurate peak stress and through thickness stress distribution can be calculated. In order to determine those quantities directly from the FE stress data it is necessary to model accurately all micro-geometrical features resulting in a very complex fine FE mesh and large numbers of elements (FIGS. 7, 8 and 9) when applied to a real full scale welded structure.

Determination of the Membrane and Bending Hot Spot Stress from the Coarse Mesh Fe Data

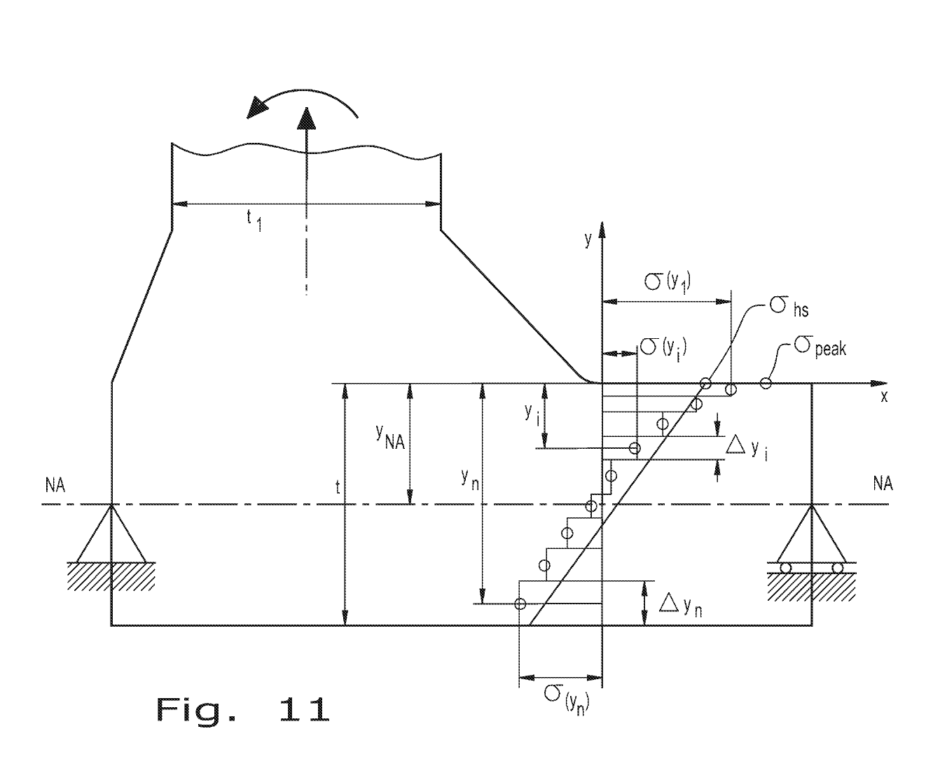

The membrane and hot spot stresses are found by so called linearization of the discrete stress field (FIG. 10) obtained from the coarse mesh FE analysis. The linearized equivalent stress field is understood as linearly through the thickness distributed stress field having the same axial force and the same bending moment as the actual nonlinear stress field. The difference between the classical nominal stress σₙ and the hot spot stress σₕₛ is that the nominal stress is determined as an average stress over the entire cross section and it is the same at any point along the weld toe line. The hot spot stress (or critical stress location) results from the linearization of the actual stress field over the plate thickness and it varies along the weld toe line. However, in order to account for the fact that the hot spot stress varies along the weld toe the linearization is carried out locally over a small part of the cross section beneath a selected point on the weld toe line, i.e., over an area ‘t×Δz’ at location (x=0, y=0, z=zᵢ), where the coordinate z=zᵢ defines the position along the weld toe. The axial force and the bending moment are determined by integrating the stress function σ(x=0, y, z) acting over the area ‘t×Δz’.

$$\begin{matrix}P = {\int }_{z = {z}_{i}}^{z = {z}_{i} + Δ z} {\int }_{y = - t}^{y = 0} σ ( x = 0 , y , z ) \cdot d y \cdot d z & ( 5 ) \\ {M}_{b} = {\int }_{z = {z}_{i}}^{z = {z}_{i} + Δ z} {\int }_{y = - t}^{y = 0} σ ( x = 0 , y , z ) \cdot ( {y}_{NA} - y ) d y \cdot d z & ( 6 )\end{matrix}$$

where: y_{NA}—is the coordinate of the neutral axis of the cross section ‘t×Δz’

Mathematically speaking the linearization of the stress field needs to be carried out only along the line (x=0, y, z=zᵢ) and over the domain [y=0; y=t]. The width ‘Δz’ of the cross section segment tends in such a case tends to zero and therefore the stress σₓₓ(y) can be assumed constant over such a small variation of coordinate ‘z’, i.e., it is independent of z. This means that the integration of the stress field along any line (x=0, y, z=zᵢ) does not involve integration with respect to the coordinate ‘z’ and therefore it can be assumed for convenience that ‘Δz=1’ and perform the integration only with respect to coordinate ‘y’. Therefore, for the discrete stress distribution and for the coordinate system, shown in FIG. 11, the axial force P and the bending moment M_{b} can be calculated from eqns. (7) and (8) respectively.

$$\begin{matrix}P = {\int }_{- t}^{0} σ ( y ) \cdot d y = {\sum }_{1}^{n} \frac{σ ( {y}_{i} ) + σ ( {y}_{i + 1} )}{2} \cdot \vert {y}_{i} - {y}_{i + 1} \vert & ( 7 ) \\ \begin{matrix}{M}_{b} = {\int }_{- t}^{0} σ ( y ) \cdot ( {y}_{NA} - y ) \cdot d y \\ = {\sum }_{1}^{n} σ ( {y}_{i} ) \cdot ( {y}_{NA} - {y}_{i} ) \cdot Δ {y}_{i}\end{matrix} & ( 8 )\end{matrix}$$

The stress field in the cross section of interest is usually given (FIG. 11) in the form of a series of discrete points [σ(yᵢ), yᵢ], i.e., nodal stresses and their coordinates. Therefore, a numerical integration routine needs to be applied in the form of appropriate summation of contributions from all nodal stress points. If the spacing (yᵢ₊ᵢ-yᵢ) between subsequent nodal points is not too large the integration can be replaced, according to eqns. (7) and (8), by the summation of discrete increments. Unfortunately, such a simple integration technique (FIG. 11), used extensively is not sufficiently accurate when applied to 3D coarse mesh FE stress data.

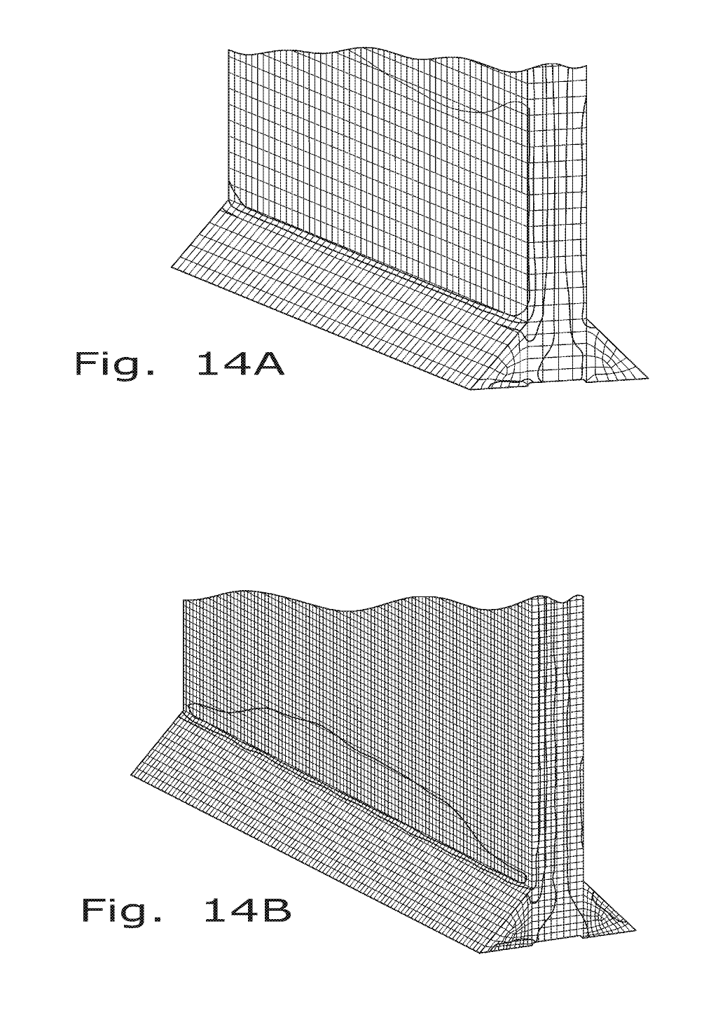

Therefore, a new numerical integration method has been developed with the present invention which is mathematically exact and applies to both fine and coarse FE mesh stress data. It is assumed in this method that simple finite elements with the linear shape function are used. Therefore, the stress field between two subsequent nodal points can be represented (FIG. 14) by a linear equation.

σ(y)=aᵢy+bᵢ (9)

where: aᵢ and bᵢ are parameters of the linear stress function valid for the range, yᵢ≦y≦yᵢ₊₁, i.e., between two adjacent nodal points.

The nodal stresses, (σᵢ, σᵢ₊₁), and their co-ordinates (yᵢ, yᵢ₊₁) respectively corresponding to two adjacent points can be used for the determination of parameters aᵢ and bᵢ of eq. (9).

$${a}_{i} = \frac{{σ}_{i} - {σ}_{i + 1}}{{y}_{i} - {y}_{i + 1}} and {b}_{i} = \frac{{σ}_{i + 1} {y}_{i} - {σ}_{i} {y}_{i + 1}}{{y}_{i} - {y}_{i + 1}} \qquad ( 10 )$$

Thus the integral (7) representing the force contributing by stresses acting over the interval, yᵢ≦y≦yᵢ₊₁, can be written as:

$$\begin{matrix}{P}_{i} = {\int }_{{y}_{i}}^{{y}_{i + 1}} σ ( y ) \cdot d y \\ = {\int }_{{y}_{i}}^{{y}_{i + 1}} ( {a}_{i} y + {b}_{i} ) \cdot d y \\ = \frac{{a}_{i} {y}^{2}}{2} + {b}_{i} y {\vert}_{{y}_{i}}^{{y}_{i + 1}} \\ = \frac{( {σ}_{i + 1} + {σ}_{i} ) ( {y}_{i + 1} - {y}_{i + 1} )}{2}\end{matrix} \qquad ( 11 )$$

In order to determine the resultant force P acting over the entire thickness of the cross section all force contributions P, need to be accounted for.

$$P = {\sum }_{1}^{n} {P}_{i} = {\sum }_{1}^{n} \frac{( {σ}_{i + 1} + {σ}_{i} ) ( {y}_{i + 1} - {y}_{i} )}{2} \qquad ( 12 )$$

A similar integration technique can be used for the determination of the bending moment M_{b}. First the bending moment M_{b,i} contributing by the segment [yᵢ, yᵢ₊₁] needs to be calculated.

$$\begin{matrix}{M}_{b , i} = {\int }_{{y}_{i}}^{{y}_{i + 1}} σ ( y ) \cdot ( {y}_{NA} - y ) \cdot d y = {\int }_{{y}_{i}}^{{y}_{i + 1}} ( {a}_{i} y + {b}_{i} ) \cdot ( {y}_{NA} - y ) \cdot d y \\ = {a}_{i} \frac{{a}_{i} {y}_{i}^{3} - {y}_{i + 1}^{3}}{3} - ( {a}_{i} {y}_{NA} - {b}_{i} ) ( \frac{{y}_{i}^{2} - {y}_{i + 1}^{2}}{2} ) - {b}_{i} {y}_{NA} ( {y}_{i} - {y}_{i + 1} )\end{matrix} \qquad ( 13 )$$

After substitution of eq. (10) into eq. (13) and rearrangement a general expression for the bending moment contributing by the segment [yᵢ, yᵢ₊₁] can be written as:

$${M}_{b , i} = \frac{( {σ}_{i} - {σ}_{i + 1} )}{( {y}_{i} - {y}_{i + 1} )} \frac{( {y}_{i}^{3} - {y}_{i + 1}^{3} )}{3} + [ ( {σ}_{i} - {σ}_{i + 1} ) {y}_{NA} - {σ}_{i + 1} {y}_{i} + {σ}_{i} {y}_{i + 1} ] \frac{( {y}_{i} + {y}_{i + 1} )}{2} - ( {σ}_{i + 1} {y}_{i} - {σ}_{i} {y}_{i + 1} ) {y}_{NA} \qquad ( 14 )$$

In order to determine the resultant bending moment M_{b} acting over the entire thickness ‘t’ all bending moments contributions M_{b,i} from all segments of the cross section need to be added together.

$${M}_{b} = {\sum }_{1}^{n} {M}_{b , i} = {\sum }_{1}^{n} \frac{( {σ}_{i} - {σ}_{i + 1} )}{( {y}_{i} - {y}_{i + 1} )} \frac{( {y}_{i}^{3} - {y}_{i + 1}^{3} )}{3} + {\sum }_{1}^{n} [ ( {σ}_{i} - {σ}_{i + 1} ) {y}_{NA} - {σ}_{i + 1} {y}_{i} + {σ}_{i} {y}_{i + 1} ] \frac{( {y}_{i} + {y}_{i + 1} )}{2} - {\sum }_{1}^{n} ( {σ}_{i + 1} {y}_{i} - {σ}_{i} {y}_{i + 1} ) {y}_{NA} \qquad ( 15 )$$

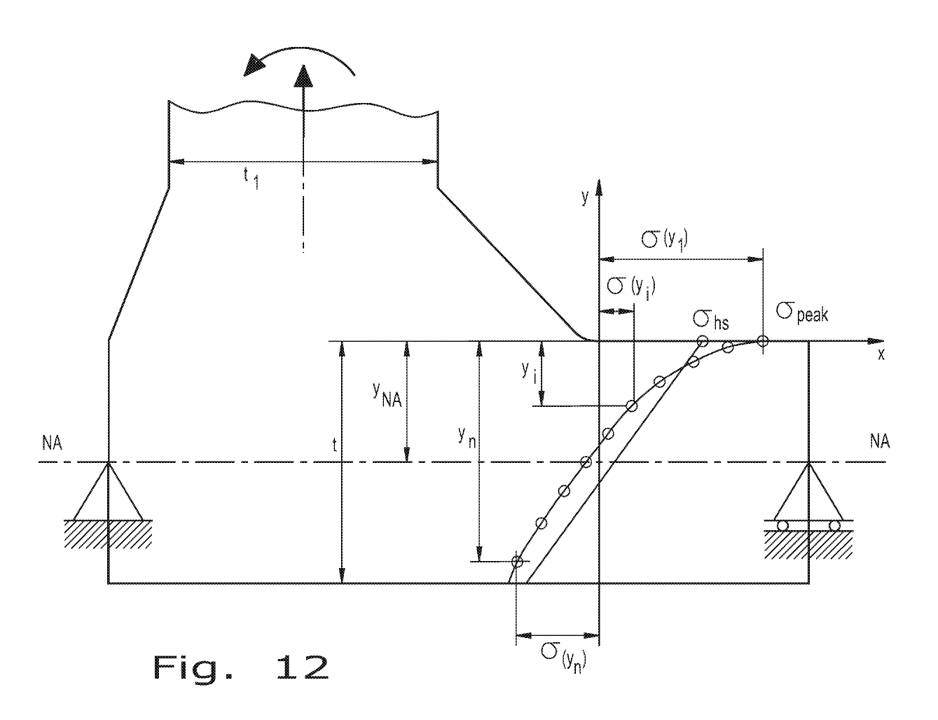

Then the membrane and bending hot spot stresses can be determined (FIGS. 11 and 12) using simple membrane and bending stress formulae.

$$\begin{matrix}{σ}_{hs}^{m} = \frac{P}{t} = \frac{1}{t} {\sum }_{1}^{n} \frac{( {σ}_{i + 1} + {σ}_{i} ) ( {y}_{i + 1} - {y}_{i} )}{2} & ( 16 ) \\ \begin{matrix}{σ}_{hs}^{b} = \frac{c \cdot {M}_{b}}{I} = \frac{\frac{t}{2} \cdot {M}_{b}}{\frac{{t}^{3}}{12}} = \frac{6 \cdot {M}_{b}}{{t}^{2}} \\ = \frac{6}{{t}^{2}} {\sum }_{1}^{n} \frac{( {σ}_{i} - {σ}_{i + 1} )}{( {y}_{i} - {y}_{i + 1} )} \frac{( {y}_{i}^{3} - {y}_{i + 1}^{3} )}{3} + \\ \frac{6}{{t}^{2}} {\sum }_{1}^{n} [ ( {σ}_{i} - {σ}_{i + 1} ) {y}_{NA} - {σ}_{i + 1} {y}_{i} + {σ}_{i} {y}_{i + 1} ] \frac{( {y}_{i} + {y}_{i + 1} )}{2} - \\ \frac{6}{{t}^{2}} {\sum }_{1}^{n} ( {σ}_{i + 1} {y}_{i} - {σ}_{i} {y}_{i + 1} ) {y}_{NA}\end{matrix} & ( 17 )\end{matrix}$$

The purpose of the coarse FE mesh analysis is to determine hot spot stresses σₕₛ^{m} and σₕₛ^{b} at specified point on the weld toe line. Therefore the linearized stress distribution, as mentioned earlier, is determined not over a small segment of the cross section but along the line [x=0, y, z=zᵢ] and the integration is carried out (FIG. 10) only over the interval (−t≦y≦0) along the y axis.

It has been found that the average membrane stress determined from equation (16), applicable to piecewise stress distribution obtained from a coarse FE mesh model, resulted in very close approximation of the actual membrane stress and as such has been recommended for finding the membrane stress for both the coarse and fine FE mesh stress data.

Unfortunately, the bending moment found by integrating (eq. 17) the stress field over the entire domain (−t≦y≦0) of the coarse FE mesh stress distribution was very inaccurate due to the strong effect of the highest and very inaccurate stress at the sharp corner imitating the weld toe line. It is also known that FE stresses near a sharp corner are very mesh sensitive and therefore they can not be used for the estimation of the bending moment.

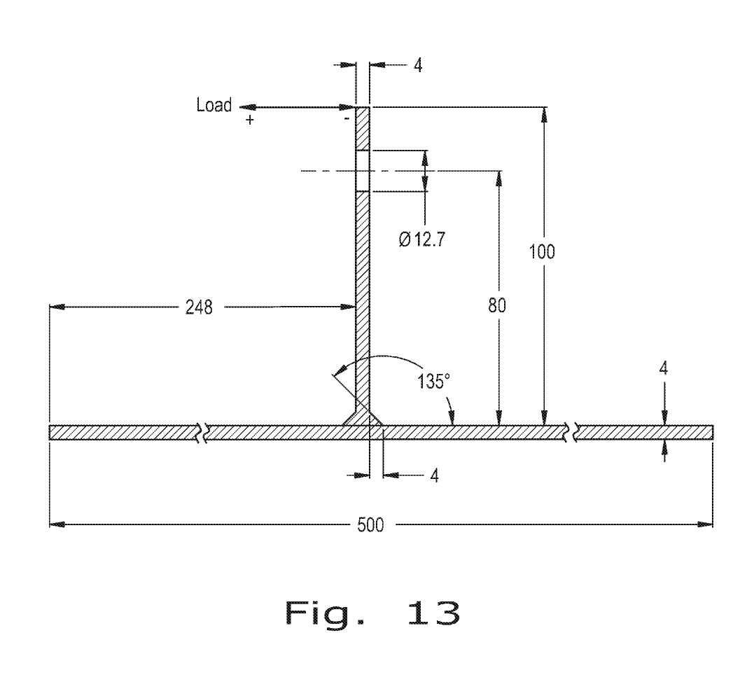

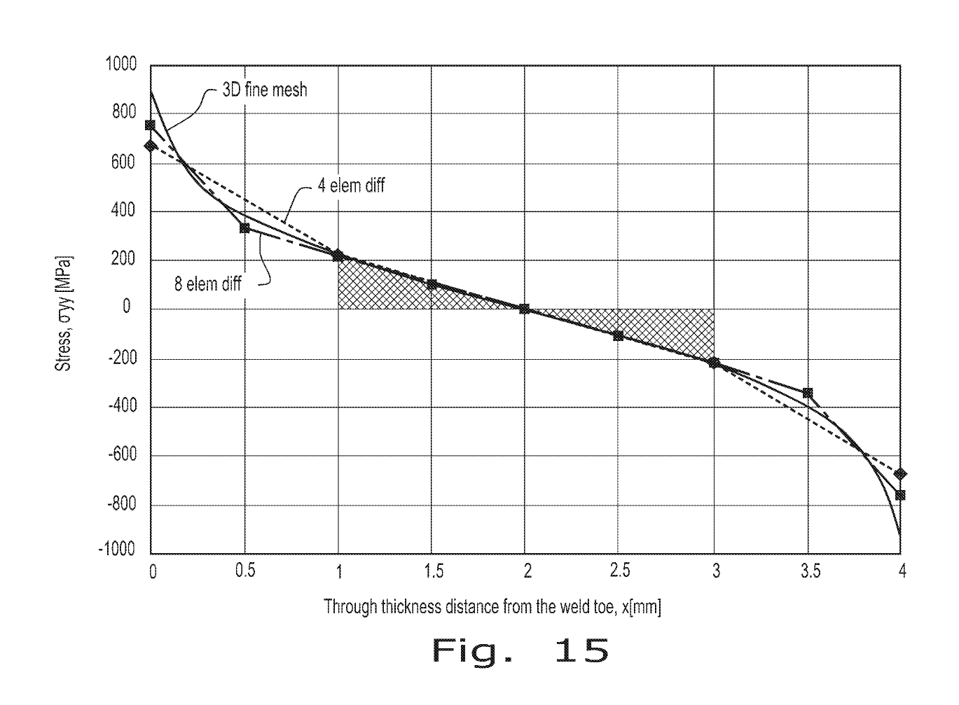

In accordance with an aspect of the present invention, it has been found by the inventors of the present invention that the mid-thickness segment (−0.75t≦x≦−0.25t) of any through thickness stress distribution in any welded joint was the same regardless of the FE mesh resolution (fine or coarse). Several welded joint configurations were studied and among them was the gusset welded joint shown in FIG. 13. The through the gusset plate thickness stress distribution σ_{yy} at the location shown in FIG. 14a and induced by the lateral force applied to the vertical gusset plate was selected for the analysis. An example of the mesh independence of the mid-thickness stress field, mentioned above, is shown in FIG. 15 where stress fields from a very fine and very coarse FE mesh are in the mid-thickness region the same. Therefore the mid-thickness region (−0.75t≦x≦−0.25t) of the stress distribution was selected as the base for the estimation of the entire bending moment and resulting bending hot spot stress acting at that location.

The bending moment contribution M_{c} from the mid-thickness part of the stress field can be determined using the well known in mechanics of materials formulae based on the decomposition of the linear stress distribution into appropriate rectangles and triangles (FIG. 16) and using their areas and centroides. Then the bending moment is determined (for Δz=1) using the following expression.

$${M}_{c} = {σ}_{3} \vert {x}_{3} - {x}_{2} \vert \frac{( {x}_{3} - {x}_{2} )}{2} + \frac{( {σ}_{3} - {σ}_{2} ) \vert {x}_{3} - {x}_{2} \vert}{2} \cdot \frac{2}{3} ( {x}_{3} - {x}_{2} ) + \frac{{σ}_{3} \vert {x}_{3} - {x}_{0} \vert}{2} \cdot \frac{1}{3} ( {x}_{3} - {x}_{0} ) + \frac{{σ}_{4} \vert {x}_{0} - {x}_{4} \vert}{2} \cdot [ ( {x}_{3} - {x}_{0} ) + \frac{2}{3} ( {x}_{0} - {x}_{4} ) ] \qquad ( 18 )$$

The bending moment M_{c} is calculated with respect to the neutral axis y=y_{NA} which coincides with the center line of the plate thickness. Expression (18) represents the integral (8) but limited to the domain of 0.25t<x<0.75t and piecewise linear stress distribution between nodal points. Expression (18) might be sometimes inconvenient in practice because the analyst must find the coordinate x₀ where the stress diagram intersects the abscissa (FIG. 16). However, for a linear stress distribution between points x₂-x₃ and x₃-x₄ (FIG. 16) the general technique in the form of eq. (13) can be applied with analytical integration over the domain limited to 0.25t≦x≦0.75t.

$${M}_{c} = {\int }_{0.25 t}^{0.75 t} {σ}_{yy} ( x ) \cdot ( {x}_{NA} - x ) d x = {\int }_{{x}_{2}}^{{x}_{4}} {σ}_{yy} ( x ) \cdot ( {x}_{NA} - x ) d x \qquad ( 19 )$$

It is assumed in the analysis presented below that the FE mesh has only four finite elements per plate thickness. Therefore, there are only three stress point values within the integration domain, σ₂, σ₃, σ₄ and corresponding coordinates x₂, x₃, x₄. The integration of eq. (19) can be done separately for the segment [x₂, x₃] and the segment [x₃, x₄]. The linear stress function in the interval [x₂; x₃], coinciding with the finite element on the left hand side of the neutral axis, can be written in the form of the linear equation (20).

σ_{yy}(x)=a₁x+b₁ (20)

Parameters a₁ and b₁ can be determined (FIG. 16) from known nodal stresses σ₂ at x₂ and σ₃ at x₃.

$${a}_{1} = \frac{{σ}_{2} - {σ}_{3}}{{x}_{2} - {x}_{3}} and {b}_{1} = \frac{{σ}_{3} {x}_{2} - {σ}_{2} {x}_{3}}{{x}_{2} - {x}_{3}} \qquad ( 21 )$$

Thus the integral (19) can be written in the form:

$$\begin{matrix}{M}_{c 1} = {\int }_{{x}_{2}}^{{x}_{3}} {σ}_{yy} ( x ) \cdot ( {x}_{NA} - x ) d x \\ = {\int }_{{x}_{2}}^{{x}_{3}} ( {a}_{1} x + {b}_{1} ) \cdot ( {x}_{NA} - x ) d x = \\ = [ {a}_{1} \frac{{x}_{2}^{3} - {x}_{3}^{3}}{3} - ( {a}_{1} {x}_{NA} - {b}_{1} ) ( \frac{{x}_{2}^{2} - {x}_{3}^{2}}{2} ) - {b}_{1} {x}_{NA} ( {x}_{2} - {x}_{3} ) ]\end{matrix} \qquad ( 22 )$$

A similar set of equations can be written for the second (FIG. 16) interval [x₃; x₄] adjacent to and being on the right hand side of the neutral axis NA.

$$\begin{matrix}{σ}_{yy} ( x ) = {a}_{2} x + {b}_{2} & ( 23 ) \\ {a}_{2} = \frac{{σ}_{3} - {σ}_{4}}{{x}_{3} - {x}_{4}} and {b}_{2} = \frac{{σ}_{4} {x}_{3} - {σ}_{3} {x}_{4}}{{x}_{3} - {x}_{4}} & ( 24 ) \\ \begin{matrix}{M}_{c 2} = {\int }_{{x}_{3}}^{{x}_{4}} {σ}_{yy} ( x ) \cdot ( {x}_{NA} - x ) d x \\ = Δ z {\int }_{{x}_{3}}^{{x}_{4}} ( {a}_{2} x + {b}_{2} ) \cdot ( {x}_{NA} - x ) d x = \\ = [ {a}_{2} \frac{{x}_{3}^{3} - {x}_{4}^{3}}{3} - ( {a}_{2} {x}_{NA} - {b}_{2} ) ( \frac{{x}_{3}^{2} - {x}_{4}^{2}}{2} ) - {b}_{2} {x}_{NA} ( {x}_{3} - {x}_{4} ) ]\end{matrix} & ( 25 )\end{matrix}$$

The total contribution to the bending moment resulting from the mid-thickness stress field is the sum of bending moments M_{c1} and M_{c2}.

M_{c}=M_{c1}+M_{c2} (26)

Another aspect of the present invention is that it has been found after extensive numerical studies of various welded joints that the ratio of the bending moment M_{c} to the total bending moment M_{b} is the same for all geometrical configurations of welded joints studied up to date.

$$\frac{{M}_{c}}{{M}_{b}} ≅ 0.1 with the error of \pm 5 \% \qquad ( 27 )$$

Therefore, the following equation (28) is used to determine the total bending moment M_{b}:

M_{b}=10·M_{c} (28)

Thus the bending moment can be determined from the coarse FE mesh (four elements per thickness) stress data using only nodal stresses σ₂, σ₃, and σ₄.

The bending hot spot stress, σₕₛ^{b}, can be finally determined from the general bending stress formula.

$${σ}_{hs}^{b} = \frac{c \cdot {M}_{b}}{I} = \frac{\frac{t}{2} \cdot {M}_{b}}{\frac{{t}^{3}}{12}} = \frac{6 \cdot {M}_{b}}{{t}^{2}} \qquad ( 29 )$$

The purpose of the analysis is to determine the membrane, σₕₛ^{m}, and bending, σₕₛ^{m}, hot spot stresses at selected point along the weld toe line. Therefore, the linearized stress distribution (FIG. 10) is determined not over a segment of the cross section but along the line [x=0, y, z=zᵢ]. The meaning of the nominal and the local linearized stress field is also illustrated in FIG. 10.

The advantage of using eq. 3 and eq. 4 and the membrane and bending hot spot stresses, σₕₛ^{m} and σₕₛ^{b}, respectively lies in the fact that only two stress concentration factor expressions are necessary, K_{t,hs}^{m} and K_{t,hs}^{b} for all fillet welds in order to determine the peak stress and the through-thickness stress distribution at any location (FIG. 10) along the weld toe line. The membrane and bending hot spot stresses, σₕₛ^{m} and σₕₛ^{b}, respectively are on the other hand mesh independent and therefore they can be determined using relatively simple and coarse finite element mesh models. Another advantage of using such an approach is that the peak stress and the through thickness stress distribution can be determined at any location along the weld toe line without any ambiguity associated with the classical definition of the nominal stress as shown in FIG. 10. The nominal stress is usually defined as a mean or simple bending stress in a cross section. The hot spot stress is obtained by the linearization of the stress distribution along any through thickness line located at any point beneath the weld toe line. The nominal stress is the same over the selected cross section area while the hot spot stress depends on the location along the weld toe line.

### Selection of Stress Concentration Factor Expressions

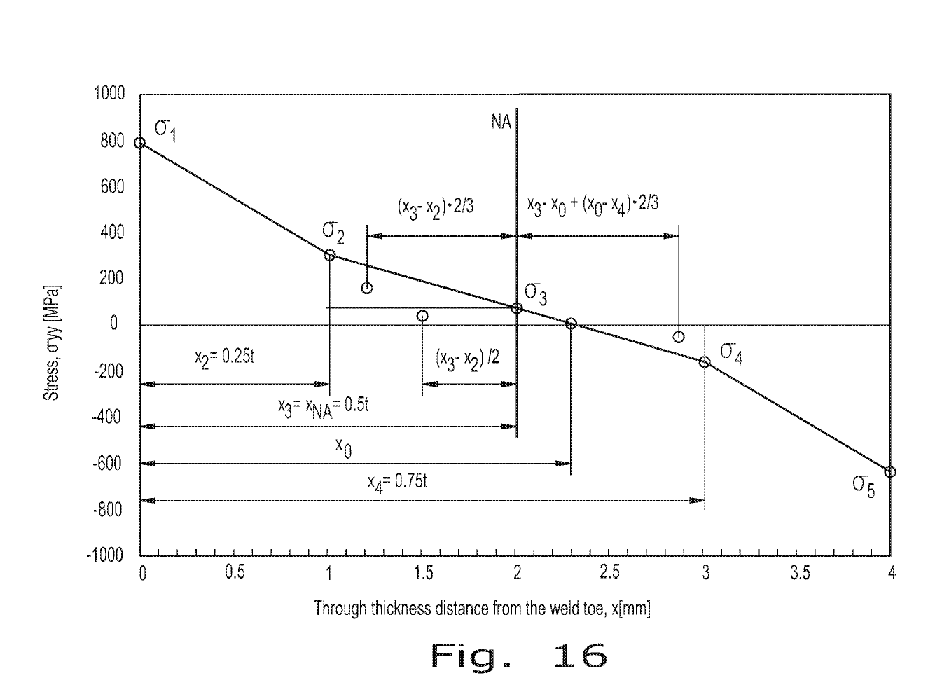

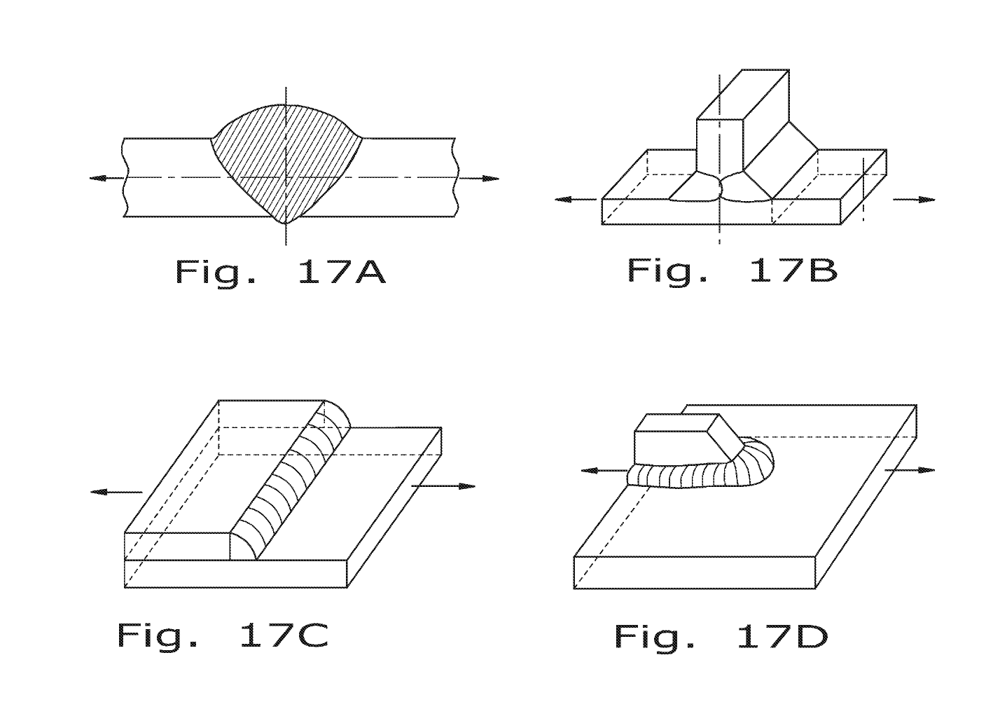

The most reliable stress concentration factor expressions as described above are the known Japanese stress concentration factors recommended by the International Institute of Welding. Weldments and machine components can be categorized as being geometrically non-symmetric or symmetric, i.e. symmetric—with welds being symmetrically located at both sides of the plate (FIG. 17) and non-symmetric—with only one weld on one side of the plate (FIG. 18). Therefore different stress concentration factor expressions have to be used for geometrically identical non-symmetric and symmetric fillet welds.

### Symmetric Butt Welds

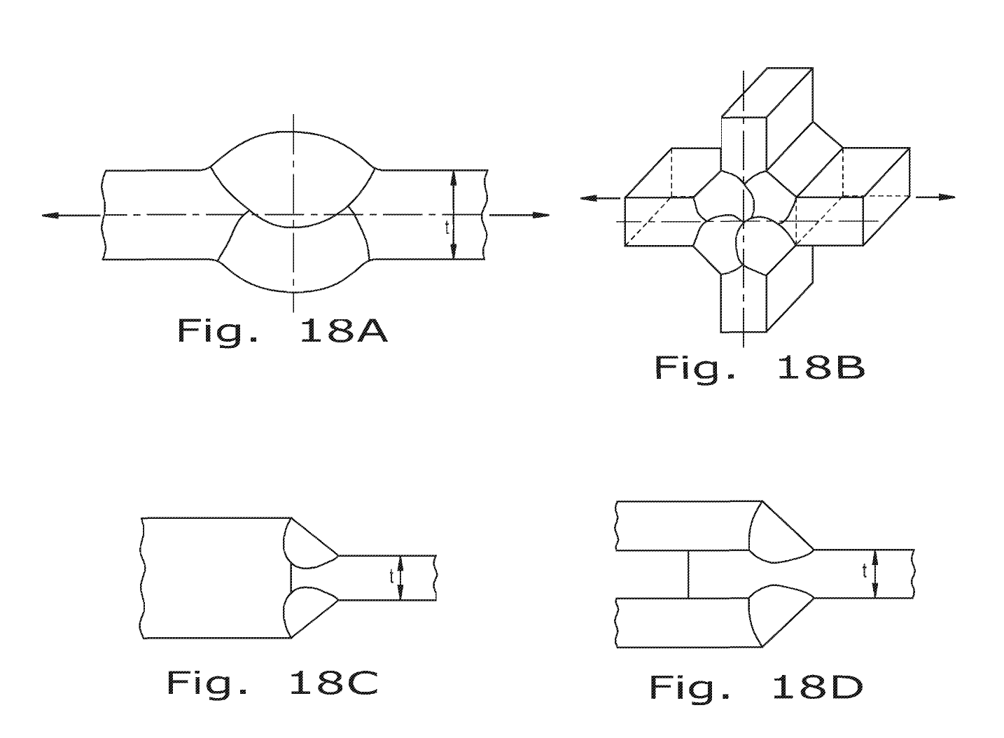

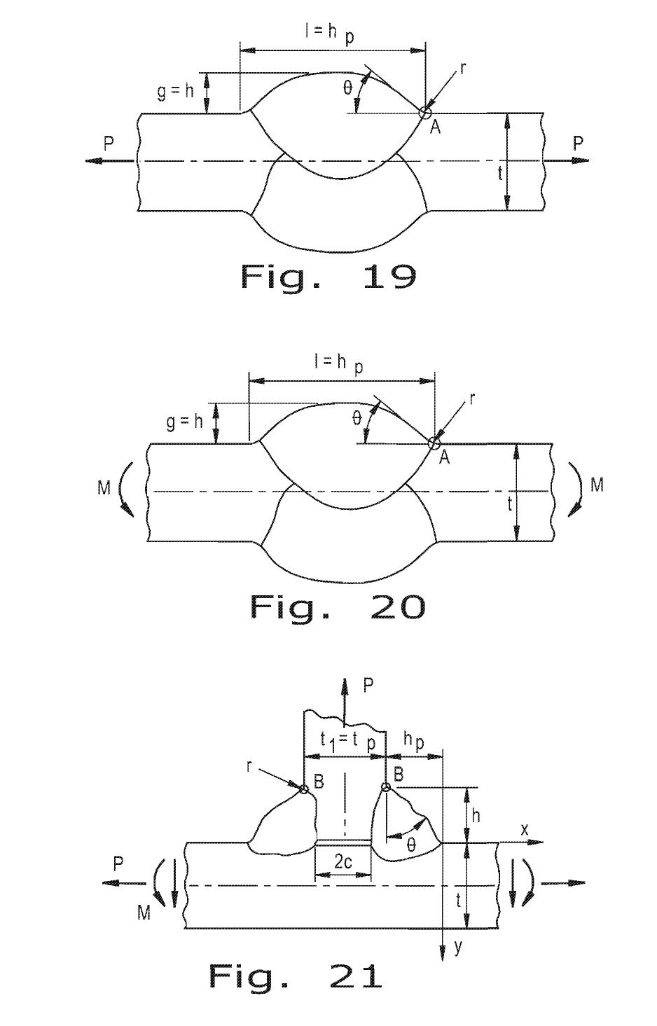

In order to calculate the stress concentration factor at the weld toe point A of a symmetric butt weld (FIGS. 19 and 20) it is recommended to use for the axial and bending load the stress concentration expression (30) and (31) respectively.

$${K}_{t , hs}^{m} = 1 + \frac{1 - exp ( - 0.9 θ \sqrt{\frac{W}{2 h}} )}{1 - exp ( - 0.45 π \sqrt{\frac{W}{2 h}} )} \times {2 [ \frac{1}{2.8 ( \frac{W}{t} ) - 2} \times \frac{h}{r} ]}^{0.65} \qquad ( 30 )$$

where: W=t+2h+0.6hₚ

$${K}_{t , hs}^{b} = 1 + \frac{1 - exp ( - 0.9 θ \sqrt{\frac{W}{2 h}} )}{1 - exp ( - 0.45 π \sqrt{\frac{W}{2 h}} )} \times 1.5 \sqrt{tanh ( \frac{2 r}{t} )} \times tanh [ \frac{{( \frac{2 h}{t} )}^{0.25}}{1 - \frac{r}{t}} ] \times [ \frac{0.13 + 0.65 {( 1 - \frac{r}{t} )}^{4}}{{( \frac{r}{t} )}^{\frac{1}{3}}} ] \qquad ( 31 )$$

where: W=t+2h+0.6hₚ

Both expressions are valid for standard geometries with parameters: r/t=0.01-0.1, g/t=0.1-0.2, l/t=0.15-2.3,θ=15°-30°.

### Symmetric Fillet Welds

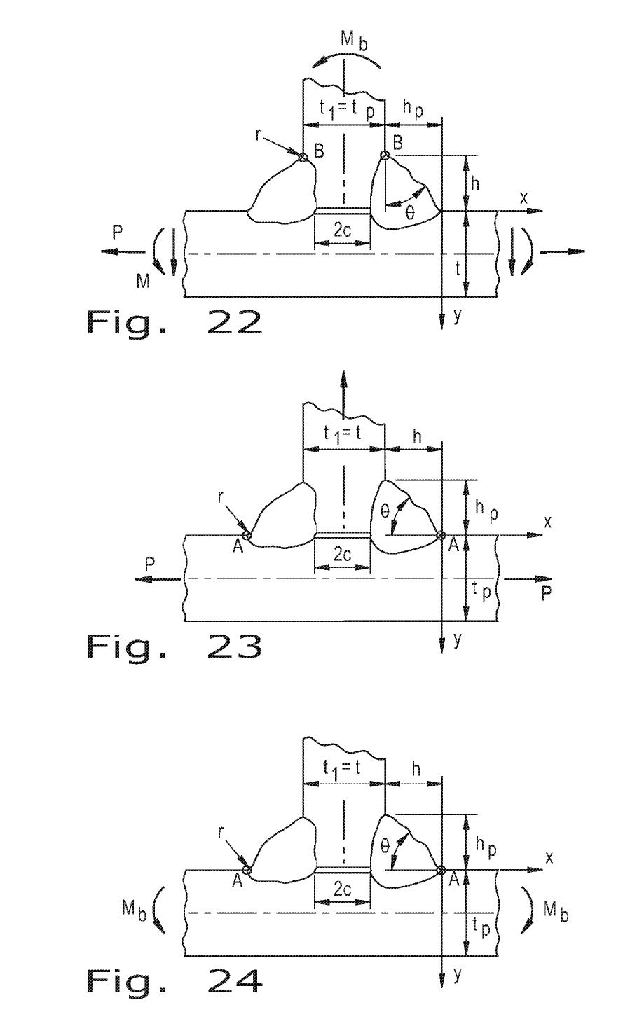

In order to calculate the stress concentration factor at the weld toe point B of a symmetric fillet weld (FIGS. 21 and 22) it is recommended to use for the axial and bending load the stress concentration expression (32) and (33) respectively.

$${K}_{t , hs}^{m} = \{ 1 + \frac{1 - exp ( - 0.9 θ \sqrt{\frac{W}{2 {h}_{p}}} )}{1 - exp ( - 0.45 π \sqrt{\frac{W}{2 {h}_{p}}} )} \times {2.2 [ \frac{1}{2.8 ( \frac{W}{{t}_{p}} ) - 2} \times \frac{{h}_{p}}{r} ]}^{0.65} \} \times \{ 1 + 0.64 \frac{{( \frac{2 c}{{t}_{p}} )}^{2}}{\frac{2 h}{{t}_{p}}} - 0.12 \frac{{( \frac{2 c}{{t}_{p}} )}^{4}}{{( \frac{2 h}{{t}_{p}} )}^{2}} \} ; \qquad ( 32 )$$

where: W=(tₚ+4hₚ)+0.3(t+2h)

$${K}_{1 , hs}^{b} = \{ \begin{matrix}\begin{matrix}1 + \frac{1 - exp ( - 0.9 θ \sqrt{\frac{W}{2 {h}_{p}}} )}{1 - exp ( - 0.46 π \sqrt{\frac{W}{2 {h}_{p}}} )} \times \\ \sqrt{tanh ( \frac{2 t}{{t}_{p} + 2 {h}_{p}} + \frac{2 r}{{t}_{p}} )} \times \end{matrix} \\ tanh [ \frac{{( \frac{2 {h}_{p}}{{t}_{p}} )}^{0.25}}{1 - \frac{r}{{t}_{p}}} ] \times [ \frac{0.13 + 0.65 {( 1 - \frac{r}{{t}_{p}} )}^{4}}{{( \frac{r}{{t}_{p}} )}^{\frac{1}{3}}} ]\end{matrix} \} \times \{ 1 + 0.64 \frac{{( \frac{2 c}{{t}_{p}} )}^{2}}{\frac{2 h}{{t}_{p}}} - 0.12 \frac{{( \frac{2 c}{{t}_{p}} )}^{4}}{{( \frac{2 h}{{t}_{p}} )}^{2}} \} ; \qquad ( 33 )$$

where: W=(tₚ+4hₚ)+0.3(t+2h)
Both expressions have been validated for the parameters:
r/tₚ=0.025-0.4; and hₚ/tₚ=0.5-1.0, θ=20°-50°.

### Non-Symmetric Fillet Welds

In order to calculate the stress concentration factor at the weld toe point A of a non-symmetric fillet weld (FIGS. 23 and 24) it is recommended to use for the axial and bending load the stress concentration expression (34) and (35) respectively.

$${K}_{t , bs}^{m} = 1 + \frac{1 - exp ( - 0.9 θ \sqrt{\frac{W}{2 h}} )}{1 - exp ( - 0.45 π \sqrt{\frac{W}{2 h}} )} \times {[ \frac{1}{2.8 ( \frac{W}{t} ) - 2} \times \frac{h}{r} ]}^{0.65} ; \qquad ( 34 )$$

where: W=(t+2h)+0.3(tₚ+2hₚ)

$${K}_{t , bs}^{b} = 1 + \frac{1 - exp ( - 0.9 θ \sqrt{\frac{W}{2 h}} )}{1 - exp ( - 0.45 π \sqrt{\frac{W}{2 h}} )} \times 1.9 \sqrt{tanh ( \frac{2 {t}_{p}}{t + 2 h} + \frac{2 r}{t} )} \times tanh [ \frac{{( \frac{2 h}{t} )}^{0.25}}{1 - \frac{r}{t}} ] \times [ \frac{0.13 + 0.65 {( 1 - \frac{r}{t} )}^{4}}{{( \frac{r}{t} )}^{\frac{1}{3}}} ] ; \qquad ( 35 )$$

where: W=(t+2h)+0.3(tₚ+2hₚ)
Both expressions have been validated for the parameters:
r/tₚ=0.025-0.4; and hₚ/tₚ=0.5-1.0, θ=20°-50°.

### Modeling the Through Thickness Stress Distribution

The general expression for the through-thickness stress distribution at a non-symmetric filet weld (FIGS. 22 and 23) as a function of two stress concentration factors and the membrane and bending hot spot stress. [2]

$$σ ( y ) = [ \frac{{K}_{t , hs}^{m} {σ}_{hs}^{m}}{2 \sqrt{2}} \cdot \frac{1}{G} + \frac{{K}_{t , hs}^{b} {σ}_{hs}^{b}}{2 \sqrt{2}} \cdot \frac{1 - 2 ( \frac{y}{t} )}{{G}_{b}} ] [ {( \frac{y}{r} + \frac{1}{2} )}^{- \frac{1}{2}} + \frac{1}{2} {( \frac{y}{r} + \frac{1}{2} )}^{- \frac{3}{2}} ] \qquad ( 36 )$$

### Where:

$${G}_{m} = 1 for \frac{y}{r} \leq 0.3$$

$${G}_{m} = 0.06 + \frac{0.94 \times exp ( - {E}_{m} \cdot {T}_{m} )}{1 + {E}_{m}^{3} \cdot {T}_{m}^{0.8} \times exp ( - {E}_{m} \cdot {T}_{m}^{1.1} )} for \frac{y}{r} > 0.3$$

$${E}_{m} = 1.05 \times {{θ}^{0.18} ( \frac{r}{t} )}^{q}$$

$$q = - 0.12 {θ}^{- 0.62}$$

$${T}_{m} = \frac{y}{t} - 0.3 \frac{y}{t} and$$

$${G}_{b} = 1 for \frac{y}{r} \leq 0.4$$

$${G}_{b} = 0.07 + \frac{0.93 \times exp ( - {E}_{b} \cdot {T}_{b} )}{1 + {E}_{b}^{3} \cdot {T}_{b}^{0.6} \times exp ( - {E}_{b} \cdot {T}_{b}^{1.2} )} for \frac{y}{r} > 0.4$$

$${E}_{b} = 0.9 {( \frac{r}{t} )}^{- ( 0.0026 + \frac{0.0825}{θ} )}$$

$${T}_{b} = \frac{y}{t} - 0.4 \frac{r}{t}$$

Equation (36) is valid over the entire thickness in the case of non-symmetric fillet welds and only over half the thickness in the case of symmetric fillet welds.

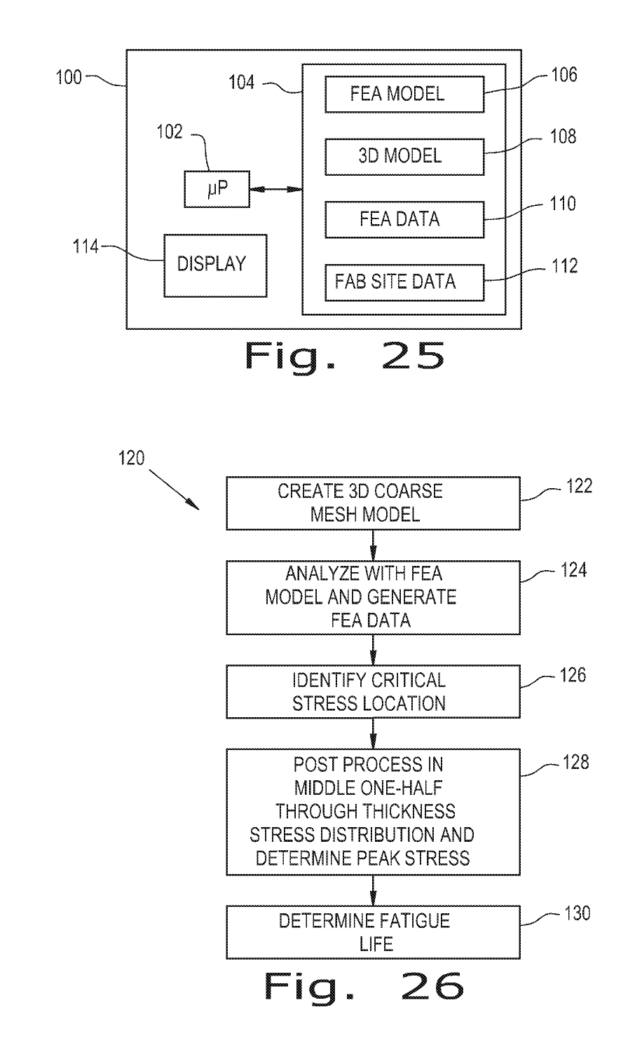

Referring now to FIG. 25, there is shown a block diagram of a computer which may be used for carrying out the computer-based method of the present invention for determining the fatigue life of a welded structure. Computer 100 generally includes at least one processor 102 and at least one memory 104. In the illustrated embodiment, computer 100 includes a single processor 102 and a single memory 104, but may include a different number of processors and memories connected together as appropriate, depending upon the particular application. Processor 102 is configured as a microprocessor with a sufficient operating speed.

Memory 104 may include software and/or data stored therein at discrete memory locations, such as FEA model 106, 3D model 108, FEA data 110 and fabrication site data 112. The FEA data 110 is the output data from the FEA model 106, based upon the data of the 3D model 108. Discrete memory blocks or sections within memory 104 may be used to store and FEA model or software program 106, 3-D model data 108, and/or FEA data 110. Computer 100 may also include an integral or attached display 114 for displaying data, calculated results, graphs, etc. to a user.

Fabrication site data 112 corresponds to empirically determined data which is used as an input variable to the mathematical equations used in the calculation of the membrane stress concentration factor K_{t,hs}^{m} and the bending stress concentration factor K_{t,hs}^{b}. More specifically, referring to FIGS. 19-24, it may be seen that each of the different types of welds includes a weld toe angle θ and a weld toe radius r. These two variables which are input into the corresponding mathematical equations for the membrane stress concentration factor K_{t,hs}^{m} and the bending stress concentration factor K_{t,hs}^{b} vary from one fabrication site to another where the welded structure is fabricated. According to yet another aspect of the present invention, data is collected for different fabrication sites and used as an input variable, depending upon the specific fabrication site where the welded structures fabricated. This fabrication site data may be stored within a discrete memory section 112 of memory 104 and used as a lookup table, or may be stored off-site from computer 100 and inputted as needed for determination of the membrane stress concentration factor K_{t,hs}^{m} and the bending stress concentration factor K_{t,hs}^{b}.

Referring now to FIG. 26, there is shown a generalized flowchart of the method 120 of the present invention for determining the fatigue life of a welded structure, which may be carried out using the computer 100 shown in FIG. 25. At block 122, a 3D coarse mesh model of the welded structure which is to be analyzed is created, typically through inputting data to computer 100, such as with a data file or manually inputting the data. The 3D coarse mesh model data is then analyzed using an FEA model (i.e., software program) 106, which as an output generates FEA data. Based on this FEA data, a critical stress location (i.e., hot spot stress location) is identified on the coarse mesh model (block 126). At this point, the method of the present invention diverges from conventional analysis techniques, in that a 3D fine mesh model is not utilized to determine the membrane and bending stresses at the identified critical stress location. Rather, the FEA data in the middle portion of the through thickness stress distribution is utilized while excluding the through thickness stress distribution near the edges of the identified critical stress location to determine a peak stress (block 128). This portion of the through thickness stress distribution has been found to be independent of the mesh size which is used when creating the 3D mesh model. While using this middle portion of the through thickness stress distribution, it has been found that the total bending moment (M_{b}) may be calculated with sufficient accuracy using the mathematical expression: M_{b}=10*M_{c}. Moreover, when calculating the membrane stress concentration factor K_{t,hs}^{m} and the bending stress concentration factor K_{t,hs}^{b} used in the peak stress calculation, fabrication site specific data is utilized for the weld toe angle and weld toe radius, thus customizing this calculation to each particular fabrication site. Based on the determined peak stress, a fatigue life for the welded structure is determined using conventional fatigue life calculation techniques (block 130).

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method of determining the fatigue life of a welded structure, said method comprising the steps of:
creating a three-dimensional (3D) coarse mesh model of the welded structure to be analyzed;
analyzing the coarse mesh model using a finite element analysis (FEA) model to generate FEA data;
identifying a critical stress location on the coarse mesh model having a through thickness stress distribution, based on the FEA data;
post processing the FEA data in the middle portion of the through thickness stress distribution while excluding the through thickness stress distribution near the edges of the identified critical stress location to determine a peak stress; and
determining a fatigue life of the welded structure at the identified critical stress location, dependent on the determined peak stress.

2. The method of determining a fatigue life of a welded structure of claim 1, wherein said post processing step includes determining a through thickness stress distribution in the middle approximate one half thickness of the of the coarse mesh model at the identified critical stress location.

3. The method of determining a fatigue life of a welded structure of claim 2, wherein the through thickness stress distribution in a middle approximate one half thickness of the coarse mesh model is used to calculate a bending moment M_{c} from the middle approximate one half thickness.

4. The method of determining a fatigue life of a welded structure of claim 3, wherein the through thickness stress distribution in the middle approximate one half thickness is independent of a mesh size of a 3D mesh model used in the FEA analysis.

5. The method of determining a fatigue life of a welded structure of claim 3, wherein the bending moment M_{c} is calculated using the mathematical expression:
$${M}_{e} = {\int }_{0.25 t}^{0.75 t} {σ}_{yy} ( x ) \cdot ( {x}_{NA} - x ) d x .$$

6. The method of determining a fatigue life of a welded structure of claim 3, wherein said post processing step includes calculating a total bending moment M_{b} at the identified critical stress location, dependent on the bending moment M_{c}.

7. The method of determining a fatigue life of a welded structure of claim 6, wherein the total bending moment M_{b} is calculated using the mathematical expression:
M_{b}=10*M_{c}.

8. The method of determining a fatigue life of a welded structure of claim 1, wherein the welded structure includes a weld having a weld toe angle and a weld toe radius, and the critical stress location is identified by extracting a normal stress component which is normal to a weld toe line within the welded structure.

9. The method of determining a fatigue life of a welded structure of claim 1, wherein the 3D coarse mesh model is defined by a minimum of four linear order elements through the through thickness of the welded structure.

10. The method of determining a fatigue life of a welded structure of claim 1, wherein said post processing step includes calculating a membrane stress (σₕₛ^{m}) at the identified critical stress location.

11. The method of determining a fatigue life of a welded structure of claim 10, wherein said membrane stress (σₕₛ^{m}) is calculated using the mathematical expression:
$${σ}_{hs}^{m} = \frac{P}{t} = \frac{1}{t} {\sum }_{1}^{n} \frac{( {σ}_{i + 1} + {σ}_{i} ) ( {y}_{i + 1} - {y}_{i} )}{2} .$$

12. The method of determining a fatigue life of a welded structure of claim 10, wherein said post processing step includes calculating a middle half-thickness bending moment (M_{c}) at the identified critical stress location.

13. The method of determining a fatigue life of a welded structure of claim 12, wherein the middle half-thickness bending moment (M_{c}) is calculated using the mathematical expression:
$${M}_{e} = {\int }_{0.25 t}^{0.75 t} {σ}_{yy} ( x ) \cdot ( {x}_{NA} - x ) d x .$$

14. The method of determining a fatigue life of a welded structure of claim 12, wherein said post processing step includes calculating a total bending moment (M_{b}) at the identified critical stress location.

15. The method of determining a fatigue life of a welded structure of claim 14, wherein the total bending moment (M_{b}) is calculated using the mathematical expression:
M_{b}=10*M_{c}.

16. The method of determining a fatigue life of a welded structure of claim 14, wherein said post processing step includes calculating a bending stress (σₕₛ^{b}) at the identified critical stress location.

17. The method of determining a fatigue life of a welded structure of claim 16, wherein the bending stress (σₕₛ^{b}) is calculated using the mathematical expression:
$${σ}_{hs}^{b} = \frac{6 \cdot {M}_{b}}{{t}^{2}} .$$

18. The method of determining a fatigue life of a welded structure of claim 16, wherein said post processing step includes empirically determining a membrane stress concentration factor K_{t,hs}^{m} and a bending stress concentration factor K_{t,hs}^{b}, dependent upon a geometry of the welded structure.

19. The method of determining a fatigue life of a welded structure of claim 18, wherein the membrane stress concentration factor K_{t,hs}^{m} and the bending stress concentration factor K_{t,hs}^{b} are each based upon a statistical determination of measured data for a fabrication site of the welded structure.

20. The method of determining a fatigue life of a welded structure of claim 19, wherein the measured data includes a weld toe angle and weld toe radius.

21. The method of determining a fatigue life of a welded structure of claim 20, wherein the empirically determined data requires input of the measured data.

22. The method of determining a fatigue life of a welded structure of claim 19, wherein the welded structure is a symmetric butt weld, and the membrane stress concentration factor K_{t,hs}^{m} is calculated using the mathematical expression:
$${K}_{t , hs}^{m} = 1 + \frac{1 - exp ( - 0.9 θ \sqrt{\frac{W}{2 h}} )}{1 - exp ( - 0.45 π \sqrt{\frac{W}{2 h}} )} \times {2 [ \frac{1}{2.8 ( \frac{W}{t} ) - 2} \times \frac{h}{r} ]}^{0.65}$$
where: W=t+2h+0.6hₚ
and wherein the bending stress concentration factor K_{t,hs}^{b} is calculated using the mathematical expression:
$${K}_{t , bs}^{b} = 1 + \frac{1 - exp ( - 0.9 θ \sqrt{\frac{W}{2 h}} )}{1 - exp ( - 0.45 π \sqrt{\frac{W}{2 h}} )} \times 1.5 \sqrt{tanh ( \frac{2 r}{t} )} \times tanh [ \frac{{( \frac{2 h}{t} )}^{0.25}}{1 - \frac{r}{t}} ] \times [ \frac{0.13 + 0.65 {( 1 - \frac{r}{t} )}^{4}}{{( \frac{r}{t} )}^{\frac{1}{3}}} ]$$
where: W=t+2h+0.6hₚ.

23. The method of determining a fatigue life of a welded structure of claim 19, wherein the welded structure is a symmetric fillet weld, and the membrane stress concentration factor K_{t,hs}^{m} is calculated using the mathematical expression:
$${K}_{1 , hs}^{m} = \{ 1 + \frac{1 - exp ( - 0.9 θ \sqrt{\frac{W}{2 {h}_{p}}} )}{1 - exp ( - 0.46 π \sqrt{\frac{W}{2 {h}_{p}}} )} \times {2.2 [ \frac{1}{2.8 ( \frac{W}{{t}_{p}} ) - 2} \times \frac{{h}_{p}}{r} ]}^{0.65} \} \times \{ 1 + 0.64 \frac{{( \frac{2 c}{{t}_{p}} )}^{2}}{\frac{2 h}{{t}_{p}}} - 0.12 \frac{{( \frac{2 c}{{t}_{p}} )}^{4}}{{( \frac{2 h}{{t}_{p}} )}^{2}} \} ;$$
where: W=(tₚ+4hₚ)+0.3(t+2h)
and wherein the bending stress concentration factor K_{t,hs}^{b} is calculated using the mathematical expression:
$${K}_{1 , hs}^{b} = \{ \begin{matrix}\begin{matrix}1 + \frac{1 - exp ( - 0.9 θ \sqrt{\frac{W}{2 {h}_{p}}} )}{1 - exp ( - 0.45 π \sqrt{\frac{W}{2 {h}_{p}}} )} \times \\ \sqrt{tanh ( \frac{2 t}{{t}_{p} + 2 {h}_{p}} + \frac{2 r}{{t}_{p}} )} \times \end{matrix} \\ tanh [ \frac{{( \frac{2 {h}_{p}}{{t}_{p}} )}^{0.25}}{1 - \frac{r}{{t}_{p}}} ] \times [ \frac{0.13 + 0.65 {( 1 - \frac{r}{{t}_{p}} )}^{4}}{{( \frac{r}{{t}_{p}} )}^{\frac{1}{3}}} ]\end{matrix} \} \times \{ 1 + 0.64 \frac{{( \frac{2 c}{{t}_{p}} )}^{2}}{\frac{2 h}{{t}_{p}}} - 0.12 \frac{{( \frac{2 c}{{t}_{p}} )}^{4}}{{( \frac{2 h}{{t}_{p}} )}^{2}} \}$$
where: W=(tₚ+4hₚ)+0.3(t+2h).

24. The method of determining a fatigue life of a welded structure of claim 19, wherein the welded structure is a non-symmetric fillet weld, and the membrane stress concentration factor K_{t,hs}^{m} is calculated using the mathematical expression:
$${K}_{t , bs}^{m} = 1 + \frac{1 - exp ( - 0.9 θ \sqrt{\frac{W}{2 h}} )}{1 - exp ( - 0.45 π \sqrt{\frac{W}{2 h}} )} \times {[ \frac{1}{2.8 ( \frac{W}{t} ) - 2} \times \frac{h}{r} ]}^{0.65}$$
where: W=(t+2h)+0.3(tₚ+2hₚ)
and wherein the bending stress concentration factor K_{t,hs}^{b} is calculated using the mathematical expression:
$${K}_{t , bs}^{b} = 1 + \frac{1 - exp ( - 0.9 θ \sqrt{\frac{W}{2 h}} )}{1 - exp ( - 0.45 π \sqrt{\frac{W}{2 h}} )} \times 1.9 \sqrt{tanh ( \frac{2 {t}_{p}}{t + 2 h} + \frac{2 r}{t} )} \times tanh [ \frac{{( \frac{2 h}{t} )}^{0.25}}{1 - \frac{r}{t}} ] \times [ \frac{0.13 + 0.65 {( 1 - \frac{r}{t} )}^{4}}{{( \frac{r}{t} )}^{\frac{1}{3}}} ] ;$$
where: W=(t+2h)+0.3(tₚ+2hₚ).

25. The method of determining a fatigue life of a welded structure of claim 19, wherein said post processing step includes determining a peak stress (σₚₑₐₖ) at the critical stress location, dependent on the membrane stress concentration factor K_{t,hs}^{m} and the bending stress concentration factor K_{t,hs}^{b}.

26. The method of determining a fatigue life of a welded structure of claim 25, wherein the peak stress (σₚₑₐₖ) is calculated using the mathematical expression:
σₚₑₐₖ=σₕₛ^{m}×K_{t,hs}^{m}+σₕₛ×K_{t,hs}^{b}.

27. The method of determining a fatigue life of a welded structure of claim 25, wherein said determined fatigue life is dependent on the peak stress (σₚₑₐₖ).

28. A computer-based method of determining the fatigue life of a welded structure using a computer having at least one processor and at least one memory, said method comprising the following steps which are each sequentially carried out within the computer:
creating a three-dimensional (3D) coarse mesh model of the welded structure to be analyzed;
analyzing the coarse mesh model using a finite element analysis (FEA) model to generate FEA data;
identifying a critical stress location on the coarse mesh model having a through thickness stress distribution, based on the FEA data;
post processing the FEA data in the middle portion of the through thickness stress distribution while excluding the through thickness stress distribution near the edges of the identified critical stress location to determine a peak stress; and
determining a fatigue life of the welded structure at the identified critical stress location, dependent on the determined peak stress.

29. The computer-based method of determining the fatigue life of a welded structure of claim 28, wherein the 3D coarse mesh model is stored within the at least one memory of the computer.

30. The computer-based method of determining the fatigue life of a welded structure of claim 28, wherein the FEA data is stored within the at least one memory of the computer.

31. The computer-based method of determining the fatigue life of a welded structure of claim 28, wherein the FEA model provides instructions to the processor to generate the FEA data.
